(19) United States
(12) Patent Application Publication
(10) Pub. No.: US 2007/0267396 A1
(43) Pub. Date: Nov. 22, 2007

(54) Welding Electrode and Device for Its Manufacture

(76) Inventors: Per-Ove Oskarsson, Goteborg (SE); Ulf Nordelof, Vastra Frolunda (SE); Oskar Santesson, Billdal (SE); Staffan Stromhage, Onsala (SE)

Correspondence Address: HARNESS, DICKEY & PIERCE, P.L.C., P.O. BOX 8910, RESTON, VA, 20195, US

(21) Appl. No.: 10/528,063

(22) PCT Filed: Sep. 16, 2003
(86) PCT No.: PCT/SE03/01444

§ 371 Date: Jun. 1, 2007

(30) Foreign Application Priority Data
Sep. 16, 2002 (SE) 0202728-2

(51) Int. Cl. B23K 9/24

(52) U.S. Cl. 219/136

(57) ABSTRACT

The present invention relates to a welding electrode (1) for use in manual arc-welding operations. The welding electrode comprises a core wire having an arc ignition portion including an arc ignition face, the cross-sectional area of said arc ignition portion being reduced relative to the main cross section of the core wire. The arc ignition portion is formed with at least one recess the mouth of which opens in the longitudinal lateral face of the core wire. The invention likewise concerns a device in the manufacture of welding electrodes for use in manual metallic arc welding operations. The manufacturing process comprises a unit for the manufacture of core wires and a unit for applying on said core wires a material forming slag and a shielding gas during the welding operation. The device has at least one shaping unit formed with at least one slitting means for forming at least one slit in one of the end portions of said core wires. It also has at least one holding means, in which said core wires are arranged to be collected in order to be advanced sequentially past the slitting means.

### TECHNICAL FIELD OF INVENTION

The present invention relates to a welding electrode for manual metallic arc welding operations, said electrode comprising an arc ignition portion including an arc ignition face. The cross-sectional area of the arc ignition portion is reduced relative to the main cross-sectional area of the welding electrode. In addition, the present invention relates to a device in the manufacture of welding electrodes for manual metallic arc welding, said manufacturing process comprising a unit for the manufacture of core wires for welding electrodes and a unit for deposing and drying materials forming slag and shielding gas on the electrode core wires.

### BACKGROUND OF THE INVENTION

Welding operations according to most welding methods require high temperatures in order to enable two metal pieces to be united. According to the oldest method, manual metallic arc welding, the source of heat is an electric arc the electric energy of which is transformed into thermal energy in the welding process and which is maintained between the tip of a coated metallic welding electrode and a work piece. The method is based on molten metal droplets from the welding-electrode core wire being directed towards a work piece while at the same time being shielded by substances from the sheathing material with which the metallic arc-welding electrode is coated. In the first stage of the welding the electric arc, also known as the arc, is generated and it is important that it strikes the work piece directly at the intended place and with the intended intensity in order that the resulting weld seam obtains the intended quality and strength. In addition, the initial arc must possess sufficient start-up reliability and intensity to ensure that it heats a previously deposited weld seam/weld sufficiently to produce an acceptable and flawless beginning of and transition into a resumed weld seam/weld with the aid of a fresh welding electrode.

In order to eliminate this problem and create a satisfactory arc also when the working conditions are difficult various methods have been suggested to increase the electric intensity in the arc ignition end of the welding electrode at the very starting moment, that is to create a so called hotstart. This object could be achieved by increasing the current intensity manually for a brief moment, but this method is inexact and there is a risk that the weld seam/weld produced thereby may not meet the strict requirements on the quality of the weld seam/weld. Modern technology makes it possible to control the current intensity by means of a micro processor, but on the one hand this technology is sensitive precisely to the conditions, cold and moisture, that may exist in the application of this welding method, and on the other, this technology is an expensive one. Instead, special metallic arc welding electrodes have been suggested, which are formed with a core wire having a reduced cross section in the area of the arc ignition portion in order in this manner to increase the electric intensity in the initial stage without regulation of the current intensity. In this manner conventional welding equipment may be used without adding to the costs.

However, these conventional welding electrodes having a reduced cross-section in their arc ignition portion are comparatively complex and consequently expensive to manufacture. One prior-art method of reducing the cross section of the arc ignition portion is to configure, for example through mechanical working, a cone-shaped arc ignition portion the diameter of which grows gradually into full cross-sectional dimensions. The shaping is performed on the wire cores one at a time, and later on, during their transportation between the various manufacturing stages, the cone-shaped tips may entangle themselves in other core wires or in the equipment. Also the process of coating a welding electrode of this kind becomes more complex since the geometry of the electrode exterior causes too much sheathing material to be deposited in order that the cylindrical outer shape of the welding electrode be maintained, with consequential drying-induced cracks in the sheath, or else a special technique is required in order to ensure that the layer of sheathing material will be of even thickness and consequently follow the external shape of the welding-electrode core wire. Another prior-art method of reducing the welding-electrode arc ignition portion is to drill in the end face of the arc ignition portion a small hole extending in the lengthwise direction of the welding electrode. This process requires high precision, since the core wire of a welding electrode normally has a diameter less than 5 mm and centering of the hole often is performed manually, which is cost consuming. In this type of cross-section reduction the drilled hole also prevents the sheathing material from penetrating fully into the hole as a consequence of air trapped therein, a feature which could be detrimental to the quality at the initial stage of the then formed weld seam/weld.

The object of the present invention thus is to obviate the problems outlined in the aforegoing and to suggest a less expensive and from a production point of view simpler welding electrode for use in manual metallic arc welding operations, said electrode having a reduced cross-section arc ignition portion while being able to sustain favourable arc characteristics at the start-up moment or in the weld seam/weld formed later.

### SUMMARY OF THE INVENTION

The object of the present invention therefore is to obviate the problems outlined above but also to provide a device in the manufacture of welding electrodes, wherein said problems are eliminated.

This object is achieved in a welding electrode of the kind defined in the introduction, which has been given the characteristic features defined in claim 1. Preferred embodiments of the welding electrode appear from the claims dependent on claim 1. The object is also achieved by means of the device having the characteristic features defined in claim 11 while preferred embodiments are defined in the dependent claims.

The present invention relates to a welding electrode for use in manual arc-welding operations, said electrode comprising a core wire having an arc ignition portion including an arc ignition face, the cross-sectional area of said arc ignition portion being reduced relative to the main cross section of the core wire. The arc ignition portion is formed with at least one recess the mouth of which opens in the longitudinal lateral face of the core wire. One consequence of forming a welding electrode with such a recess in its arc ignition portion is that the amount of material in said arc ignition portion will be reduced in comparison with the amount of material normally found in the cross section. The reduction of material in the core wire results in an increase of the electrical current intensity in the arc ignition portion compared with the case in a standard welding electrode, and consequently it provides the sought-after advantages, viz. increased probability of immediate arc starting, a more stable and therefore more controllable direction of the arc and increased development of heat at the moment of arc start-up, ensuring that the transition to the previously deposited weld seam/weld becomes as even and as faultless as possible. All these properties are particularly desirable for example in welding operations carried out on pipelines, where the welding conditions could be most difficult.

In addition, owing to the provision in this manner of a recess produced by removal of material in the electrode core wire and having its mouth opening on the core wire envelope face, the external shape of the core wire is essentially retained, which may be of great importance in the manufacture of welding electrodes. For in accordance with a common manufacturing process the core wires, and subsequently the welding electrodes, are partly transported in their lengthwise extension, whereby, if formed with an arc ignition portion tapering towards the arc ignition end, the welding electrodes may wedge themselves in between the core wires in front and the conveyor belt, or in between other parts involved in the manufacturing process. In both cases, the result may be breakdown of the manufacturing process and in consequence thereof economical losses. Thus, the feature in accordance with the present invention of essentially retaining the external shape of the core wire reduces this manufacturing problem.

Another advantage provided by the present invention at the moment of start-up is that the external circumference in the arc ignition face of the core wire mainly remains intact. Should the circumference instead be heavily reduced, as is the case in the cone-shaped arc ignition portions of prior-art technology, it may be necessary to start up the arc while the welding electrode assumes a position essentially almost at right angles (90°) to the face of the work piece. This is due to the fact that the material in the circumference of the arc ignition face of the core wire will be spaced further away from the work piece at the moment when the welding electrode is held in a position at a smaller angle (<90°) to the work piece if the arc ignition portion is cone-shaped than if its circumference on the whole is intact. This means that in order for start-up to take place, the arc must on the one hand bridge a larger space between the arc ignition face and the work piece and on the other must pass through a larger amount of sheathing material. In order to ensure a high degree of arc start-up reliability it might be necessary to sacrifice to some extent the initial hotstart effect. In the present case, the welding electrode 1 has an arc ignition face formed with a non-reduced cross section but immediately interiorly of said face its core wire is formed with the reduction referred to in the introduction. It is important, however, that the first non-reduced portion of the arc ignition face is made as thin as possible from a manufacturing point of view such that the sought-after hotstart effect will be achieved.

Likewise, it is often advantageous that the mouth of said recess also has an extension in over the arc ignition face. One consequence of this arrangement is that the reduction of the cross section of the core wire is not made precisely interiorly of the ignition face but in the ignition face, which further enhances the effects mentioned previously.

From an aspect of manufacturing technique it is an added advantage if said recess is a notch. It is easy to manufacture by employing any one of prior-art cutting techniques.

Preferably, said recess opens in two oppositely positioned longitudinal lateral face portions of the core wire. Tests performed with welding electrodes having a reduced arc ignition portion have shown that if the reduction is essentially symmetric or is distributed wider across the ignition face, the arc becomes more stable and predictable as to its behaviour. One manner of achieving such distribution is to make the recess open in more than one lateral face portion.

Preferably, said recess forms a slit. By slit should be understood herein a recess forming a narrow open channel in the ignition portion of the welding electrode 1.

Preferably, said recess is rectilinear. This arrangement facilitates the process of manufacturing the recess and consequently it is also less expensive. Likewise, it may make introduction of sheathing material into the recess, should this be present, more convenient.

From the aspect of manufacturing technique the mouth of said recess preferably has an extension as seen in the longitudinal direction of the welding electrode.

In addition, it is preferably that said recess extends through the centre of the ignition face. A symmetrically shaped recess produces a more stable arc than a non-symmetrical one, with resulting improved welding results.

The core wire preferably is coated with a material that forms slag and shielding gas during the welding operation, and said recess is filled with said shielding-gas forming material. On the one hand, this slag and shielding-gas forming material serves to shield the material of the weld seam/weld from detrimental reactions with the oxygen in the air during the very welding operation, and on the other the use of a filler of this kind offers advantages also in the manufacturing and handling stages of the core wires. The sheathing material present in the recess has a cohesive effect in the ignition portion with consequential higher degree of flawlessness compared with a core wire formed without such a filler.

Preferably, said recess is filled with the material forming slag and shielding gas. In the absence of air trapped in the recess the core wire will behave in a stable manner, also at the moment of arc ignition.

Preferably, the recess should extend 3-9 mm, more preferably 4-8 mm and most preferably 5-7 mm in the lengthwise direction of the welding electrode and have a width (a), calculated across the longitudinal direction of the electrode that corresponds to a reduction of the diameter of the core wire by 30-40%. A recess narrower than indicated in the range reduces the hotstart effect to the point of finally disappearing entirely. A recess wider than indicated in that range, on the other hand, might produce a hot-start effect that is too explosive and therefore difficult to handle, and during the manufacture of the welding electrode 1 the recess may tend to collapse.

The present invention also comprises a device for the manufacture of welding electrode 1 for use in manual metallic arc welding operations, said manufacturing process comprising a unit for the manufacture of core wires and a unit for applying on said core wires a material forming slag and a shielding gas during the welding operation, said device having at least one shaping unit formed with at least one slitting means for forming at least one slit in one of the end portions of said core wires, and at least one holding means, in which said core wires are arranged to be collected in order to be advanced sequentially past the slitting means. The advantages found in the welding electrode 1 manufactured in this manner will not be discussed in more detail than indicated above. However, a device possessing the above characteristics is advantageous in that it allows such a welding electrode 1 to be manufactured in a simple and consequently less expensive manner. In the holding means, the core wires are collected and are moved sequentially, one by one, past the slitting means. The technique of forming the recess in the slitting means could be any one of those available for forming a recess in a metallic material. The holding means ensures that the sequence of core wires is maintained, that the core wires are advanced in a stable manner past the slitting means, and that the forming of the recesses thus can be carried out in a correct manner.

Preferably, the device comprises a conveyor means arranged to move the core wires essentially in the longitudinal direction of said wires. To move the core wires in their longitudinal direction requires little space and a minimum of control means. However, in some cases it may be of interest to move them in their transverse direction, for example in adaptation to the conveying direction employed in adjacent machines.

Further, it is preferable that the conveyor means is arranged to displace the core wires in their transverse direction in the section of the slitting means. This arrangement enables the slitting means to form recesses in an efficient manner in that the arc ignition portion of the core wires is turned towards the slitting means and consequently it becomes possible to achieve a high rate of production.

Suitably, the conveyor means is also arranged to displace the core wires in inter-parallel relationship in the section of the slitting means. In this manner the highest possible productivity is achieved since the slitting means is working constantly.

When the conveyor means is also a holding means no additional devices are needed for the conveyance function as such, resulting in economy of space as well as expenses.

Advantageously, from a production aspect, said shaping unit is placed after the cutting unit and before the application unit, as seen in the order of manufacture. In this manner the recess is being formed at a stage when the core wires have been cut into the intended lengths but before the sheathing material has been applied on the core wires, since normally, it is advantageous that the recess too is filled with this material.

In said holding means in the section of said one end portion of the core wires the device preferably is formed with an opening for access by the slitting means.

In the section of the opposite end portion of the core wires said device is formed with a guide means to guide the core wires towards said slitting means. A guide means of this kind guides the core wires towards the slitting means in a simple and consequently inexpensive manner while at the same time the core wires are pressed against, or in any case are held in abutment against the slitting means during the recess-forming step.

It is advantageous to form the slitting means with a sawing tool. The slitting means likewise could comprise a saw band. The latter may be continuous.

Preferably the holding means is arranged to displace the core wires in an essentially vertical direction. This arrangement reduces the need for space, for example for the purpose of adding a device of this kind to an existing welding-electrode production line. However, it may be preferred to arrange for the core wires to be displaced in an essentially horizontal direction, should the other devices use this direction of conveyance.

It is an advantage to arrange the holding means to move the core wires past said slitting tool by making use of the inherent gravity of the core wires. In consequence thereof no additional equipment is required to move the core wires during this production step, which also is a cost-saving feature.

Likewise it is an advantage if the direction of movement of the cutting part of the slitting means forms an angle relative to the said one end portion of the core wires. The engagement of the slitting means thus will increase gradually from zero to full engagement and contribute to the stability of the device.

Preferably, the saw band is arranged to travel around deflection wheels. This arrangement facilitates exchange of saw bands for maintenance and repair.

It is also advantageous to arrange for the holding means to retain the core wires in an essentially horizontal position.

The slitting means could comprise a circular saw blade. A saw means of this kind requires little space and could be arranged in a fixed position or on a moving arm, depending on the requirements in the individual case.

Finally, when the core wires are conveyed in, horizontal relationship through the device it may be advantageous to design the holding means, which also serves as a conveyor means, with a wedge-shaped profile configuration, in which wedge-shaped spaces the core wires may be supported during their transportation and the forming of the recess. The wedge-like shape makes each one of the circular core wires fall one by one into such a wedge space, separated from each other. This arrangement facilitates the distribution of wires in the holding means, preventing two core wires from being received in the same wedge, which on the one hand could damage the device and on the other increase the number of flawed recesses. In addition, the same holding means could be used for the manufacture of different wire dimension, i.e. core wires having different diameters. The process of positioning the core wires relative to the equipment designed to form the recess is effected by the very slitting means. In this case, the wedge shape prevents the core wires from getting stuck in the holding means and instead they may be lifted off the latter in a simple manner.

### BRIEF DESCRIPTION OF THE DRAWINGS

The invention will be described in the following in more detail by means of one embodiment with reference to the accompanying drawings that for exemplifying purposes show a presently particularly preferred embodiment. In the drawings:

FIG. 1a is a perspective view of a standard welding electrode 1.

FIG. 1b is a lateral view of an standard welding electrode 1.

FIG. 1c is an end view of a standard electrode.

FIG. 2a is a perspective view showing a welding electrode 1 formed with a cone-shaped ignition end.

FIG. 2b is a perspective view showing a welding electrode 1 formed at its ignition end with a lengthwise hole.

FIG. 2c is a perspective view showing a welding electrode 1 formed with a cone-shaped ignition end.

FIG. 3 is a broken perspective view showing a welding electrode 1 in accordance with the present invention.

FIG. 4a is a broken perspective view showing an alternative embodiment of a welding electrode 1 in accordance with the present invention.

FIG. 4b is a broken perspective view showing an alternative embodiment of a welding electrode 1 in accordance with the present invention.

FIG. 4c is a broken perspective view showing an alternative embodiment of a welding electrode 1 in accordance with the present invention.

FIG. 4d is a broken perspective view showing an alternative embodiment of a welding electrode 1 in accordance with the present invention.

FIG. 4e is a broken perspective view showing an alternative embodiment of a welding electrode 1 in accordance with the present invention.

FIG. 4f is a broken perspective view showing an alternative embodiment of a welding electrode 1 in accordance with the present invention.

FIG. 4g is a broken perspective view showing an alternative embodiment of a welding electrode 1 in accordance with the present invention.

FIG. 4f is a broken perspective view showing an alternative embodiment of a welding electrode 1 in accordance with the present invention.

FIG. 4g is a broken perspective view showing an alternative embodiment of a welding electrode 1 in accordance with the present invention.

FIG. 4h is a broken perspective view showing an alternative embodiment of a welding electrode 1 in accordance with the present invention.

FIG. 5 is a block diagram showing the process of manufacturing welding electrode 1 in accordance with the present invention.

FIG. 6 is a lateral view of a device for the manufacture of welding electrode 1 for use in manual metallic arc welding,

FIG. 7 is a perspective view showing another embodiment of a device for the manufacture of welding electrode 1 for use in manual metallic arc welding.

### DETAILED DESCRIPTION OF PREFERRED EMBODIMENTS

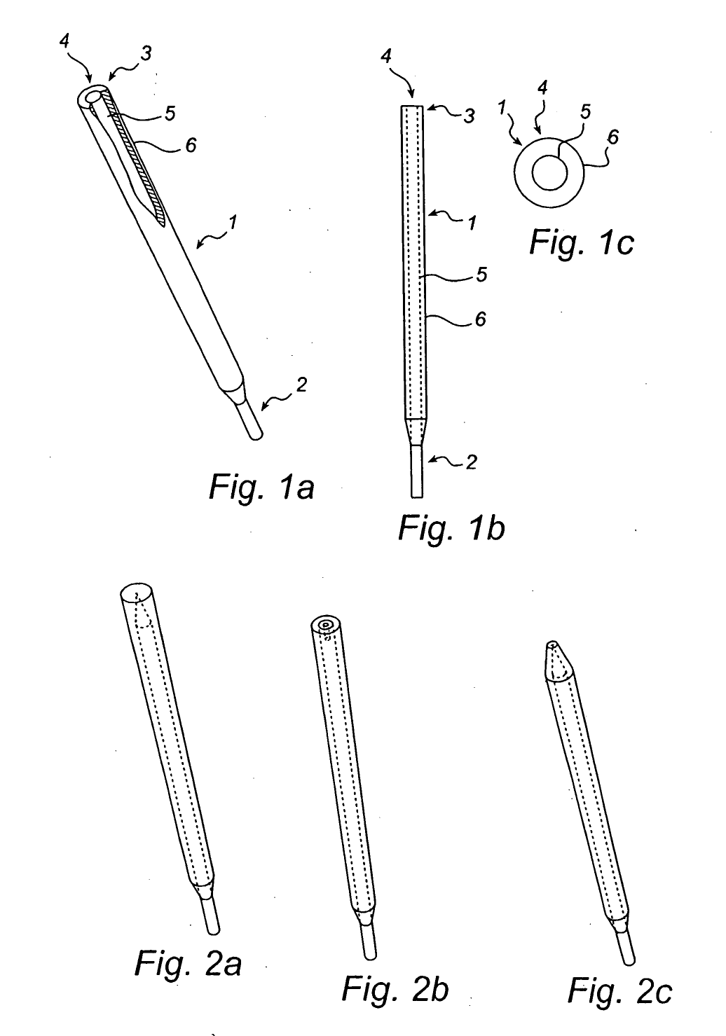

FIG. 1a shows a conventional welding electrode 1 in accordance with prior-art technology. The welding electrode 1 has a cylindrical core wire 5, enclosed by a sheath 6. The core wire 5 may consist of metallic materials of various types, depending on the intended use. In turn, the sheath 6 is made from a sheathing material that is transformed, during the welding operation, into slag, shielding gas and in some cases alloys, and serves to shield the weld metal of the core wire 5 from the surrounding atmosphere. In the manufacture of the welding electrode 1 the sheath 6 is applied in paste form, which is later heated and dried. Before the drying, an ignition face 4 is brushed clean of sheathing material in order to be able to ignite in welding. Also a holder part 2, located at the opposite end of the welding electrode 1, is brushed clean of sheathing material in order to create satisfactory contact with a holder (not shown) that transfers electric current to the welding electrode 1. Prior to the drying step the welding electrode 1 are also marked for subsequent identification. The welding proper with the aid of welding electrode 1 of this design is started by applying electric current and moving the holder including the welding electrode 1 towards the work piece, whereby an electric arc is generated between the ignition face of the welding electrode 1 in the ignition part 3 thereof and the work piece.

FIGS. 1b and 1c show the same welding electrode 1 as FIG. 1a. FIG. 1b shows the welding electrode 1 in a lateral view and FIG. 1c in an end view as seen from the ignition face.

FIGS. 2a, 2b and 2c show modified welding electrode 1 in accordance with prior-art technology. The modification consists in a reduction of the cross-sectional area of the core wire 5 in the ignition portion 3 relative to the rest of the wire. The purpose of the reduction of the cross sectional area of the core wire 5 is to increase the energy density, which results in a temperature rise in the material at the moment of arc initiation, in order thus to provide a welding electrode 1 possessing such qualities as high ignition reliability and arc stability while at the same time providing a satisfactory transition to the previously deposited weld seam/weld. FIG. 2a shows an ignition portion 3 wherein the diameter of the core wire 5 gradually decreases in the direction towards the ignition face 4. The sheath 6, on the other hand, is formed with an overall constant diameter. FIG. 2b shows an ignition portion 3, wherein a hole has been drilled in the longitudinal direction of the welding electrode 1, away from the ignition face 4. FIG. 2c shows a welding electrode 1 formed with a similar cross-sectional area reduction in the ignition portion 3 as in FIG. 2a but wherein the sheath 6 follows the external contour line of the core wire 5.

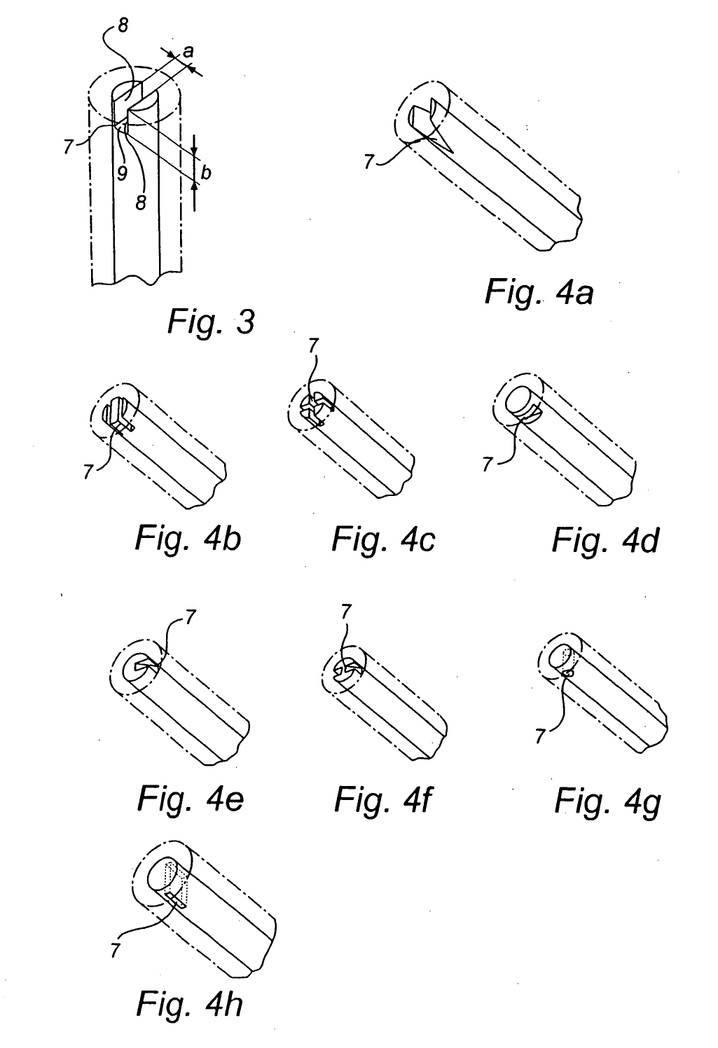

The present invention will be described in the following with reference to FIG. 3. A slit 7 has been formed in the ignition end 3 of the welding electrode 1, said slit extending in the longitudinal direction of the core wire 5 and centrally and symmetrically across the ignition face 4. The slit 7 is delimited by two oppositely positioned lateral faces 8 and a bottom face 9. In accordance with the preferred embodiment the lateral faces 8 are essentially flat and extend in parallel in the longitudinal direction of the welding electrode 1. The bottom face 9 extends between the lateral faces 8, essentially along the ignition face 4. The width of the slit 7 as calculated at right angles to the longitudinal direction of the welding electrode 1 is designated a and the length of the slit 7 as calculated in parallel with the longitudinal direction o welding electrode 1 is designated b. For best effect in use these dimensions should be adapted to the diameter of the core wire 5. However, it has been found advantageous to keep the length b essentially constant, provided that in accordance with prior-art technology the current intensity is adapted, during welding, to the core-wire diameter in such a manner that the current intensity in the ignition face is approximately equal for all welding electrodes 1, irrespective of their diameter. The length b controls the melting time of the welding electrode 1 and when it is constant by a predetermined value the increase of current intensity has time to generate an improved gas shield and create a hotter melt initially while at the same time the effects do not remain for too long but allows normal welding conditions to be performed. It is important that the width a is not too large in relation to the diameter of the core wire because should that be the case the remaining amount of material could collapse during the manufacture, for example when supply rolls advance the core wires in a conveyor belt. The reduction of ignition-face area likewise controls the intensity of welding electrode melting and for that reason it is important that the reduction is not too large as this could result in too intensive an effect. Tests performed with differently designed welding electrode 1 in accordance with the present invention have shown that it is advantageous to form the slit 7 with a width a and a depth b corresponding to a reduction of the volume of the ignition portion 3 by approximately 35 to 50%. For optimum performance, the depth of the slit 7 should be in the range of 3 to 9 mm, more preferably in the range of 4 to 8 mm and most preferably in the range of 5 to 7 mm. Thus the width b must be adapted to these depth dimensions and to the diameter of the core wire 5 being used. A welding electrode 1 the core wire of which is 2.5 mm preferably is formed with a recess having a width of 1 mm and a core wire having a diameter of 4.0 mm preferably is formed with a recess having a width of 1.5 mm. The reduction of the ignition portion of the core wire thus should ensure that the width of the recess is in the range of 30 to 45% of the diameter of the core wire.

The slit 7 is filled with the sheath metal in the manufacturing process and after having been dried the material contributes to the cohesion and the formation of a faultless bridge between the two tongues formed by the core wire 5 in the ignition portion 3. Since it is possible to fill the slit 7 with sheathing material it likewise becomes possible to apply an ignition booster.

As should be appreciated numerous modifications of the above embodiment are possible within the scope of protection of the invention as defined in the appended claims. FIGS. 4a-4h show some examples of such modifications. FIG. 4a shows an ignition portion 3 which is formed with a recess 7 the shape of which would be most accurately described as a V-shape, the lateral faces of which converge in a tip and which thus is without a bottom face 9. However, the recess could be formed with a bottom face, should this be desired. FIG. 4b shows an ignition portion 3 formed with two parallel slits 7. The reason for the arrangement of more than one recess 7 could be that a welding electrode 1 having a large cross-sectional diameter would pick up too much sheathing material in one area. Double slits could also, as illustrated in FIG. 4c, be arranged-crosswise. If for some reason it is important that a large amount of core wire material be available at the moment of ignition while at the same time one wants to achieve the effect of a so called hotstart, the recess could instead be arranged to extend in parallel with the ignition face 4, as shown in FIG. 4d, or be configured as a through-passage recess 7 extending in parallel with the ignition face, in the form of a hole as shown in FIG. 4g or else, as shown in FIG. 4h, as a through-passage aperture having a more rectangular configuration. In the case of all these three embodiments it is important that the recess be placed immediately below the ignition face 4 in order that the hotstart effect be obtained. In contrast, should it instead be desired that the reduction of the cross-sectional area of the core wire 5 be small in relation to its diameter it is possible to form the recess 7 with a bottom face 9 extending from the ignition face 4 towards the envelope face of the core wire 5. One example of a recess 7 of this nature is shown in FIG. 4e and another one involving a double recess 7 is shown in FIG. 4f.

Furthermore, the ignition portion 3 may be reduced further in other ways within the scope of protection of the invention. A slit 7 could be given an extension along the welding electrode 1 that differs from one in parallel with said welding electrode 1.

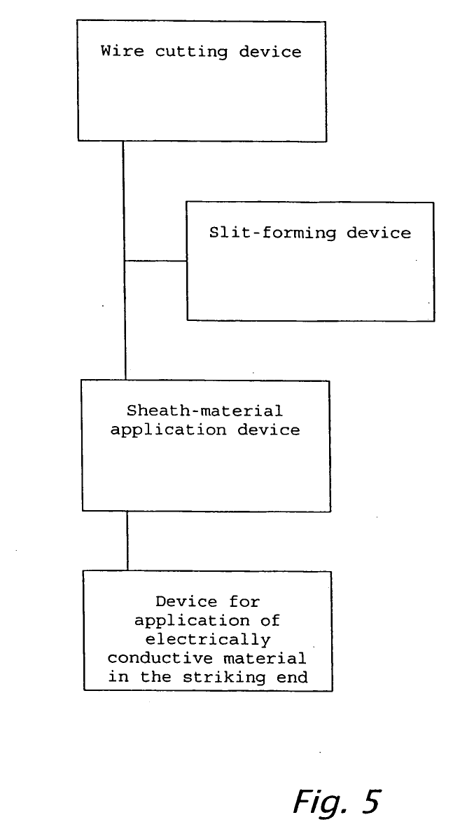

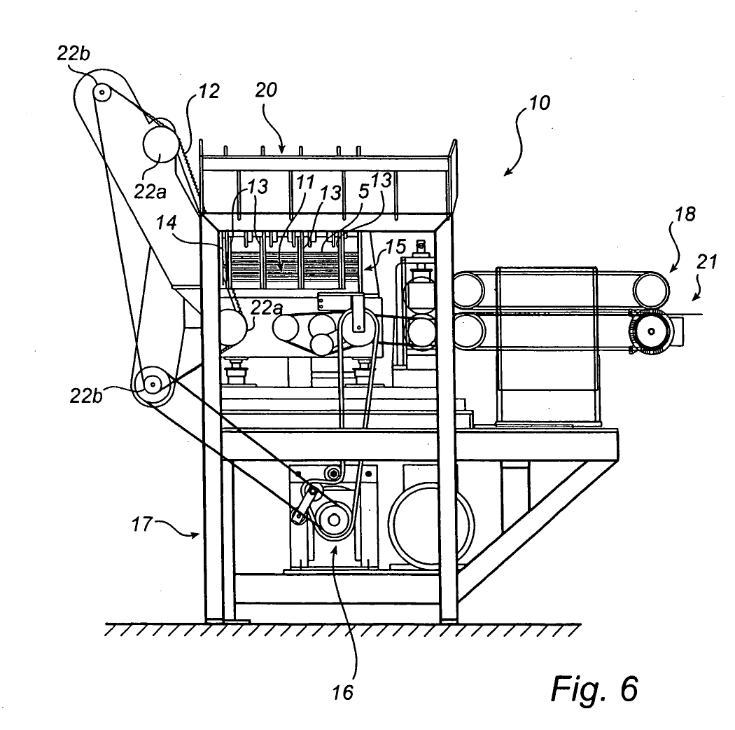

A preferred embodiment of a device for use in the manufacture of welding electrode 1 for manual metallic arc welding will be described below. A manufacturing process is illustrated in schematic form in FIG. 5 and the manufacturing device 10 is shown in FIG. 6, illustrating the device as a unit which is separated from others involved in the manufacturing process and therefore may be located in an existing welding electrode manufacturing process. A manufacturing process of this kind in accordance with the prior art involves at least one device for cutting wire into core wires 5 of the desired length (or other types of manufacturing core wires, such as by means of casting) and one device for application of sheathing material over the entire length of the core wire 5, the ignition face 4 and the holding portion 2 being brushed clean in a later stage from sheathing material in order to allow contact between a work piece and the ignition face 4 and between a holder and the holding portion 2. The ignition face 4 is dried and finally receives an electrically conductive material in order to further increase contact between the work piece and the ignition face 4. The device 10 in accordance with the present invention is located after the device for cutting wire into core wires 5 and before the device for application of sheathing material 6. In this manner sheathing material 6 is applied also in the recess 7 at the same time as such material is applied on the rest of the core wire 5.

The device 10 comprises a feed-in portion 20 for supply of core wires 5 and one core wire feed-out portion 21 and it is constructed around a frame 17 supporting said device, and it also comprises a drive unit 16 positioned vertically below the active part of the device and arranged via drive belts 19 to actuate on the one hand a saw blade 12 and on the other means conveying the core wires 5 through the device 10. The core wires 5 are advanced in their longitudinal direction of extension from a container, not shown, from the previous manufacturing step up to the collection magazine 11 via an advancement means, not shown and opens vertically above a vertically disposed collection magazine 11 in the feed-in portion 20. In this area the advancement means are arranged to redirect the advancing core wires 5 such that they move past the collection magazine 11 in their transverse direction of extension. The core wires 5 are collected in the collection magazine 11, one on top of the other, and owing to their inherent gravity they fall vertically downwards against the saw blade 12 located at one end of the collection magazine 11. The collection magazine 11 comprises guide rails 13 arranged to support the core wires 5 on either said of their path of travel, an opening in the end portion turned towards the saw blade 12 in order to give the saw blade 12 access to the ignition portion 3 to be slit, and a guide means 15 in the form of a plate-like arm the object of which it is to guide the core wires 5 horizontally against the saw blade 12. The saw blade 12 engages the ignition portion 3 of the core wires 5 centrally at an angle to the vertical plane and to the ignition portions 3 of the core wires 5. The angle is set to ensure that the length of the recess 7 at the bottom of the collection magazine 11 will be the intended one and the thickness of the saw blade 12 is adapted to ensure that the width of the recess 7 will be the intended one. In the area of the collection magazine 11, the saw blade 12 travels around two saw deflection wheels 22a while assuming a sawing position, i.e. the saw edge is turned in the direction of engagement. The angle of the saw blade 12 is then shifted by 90° and the blade will then assume a lying position and in this condition it travels around another two saw deflection wheels 22b before it is again redirected so that the saw blade assumes its sawing position. When the core wires 5 have passed the collection magazine 11 they are again redirected by a feed-out unit 18 and are conveyed in their longitudinal extension for further transport to the following manufacturing step.

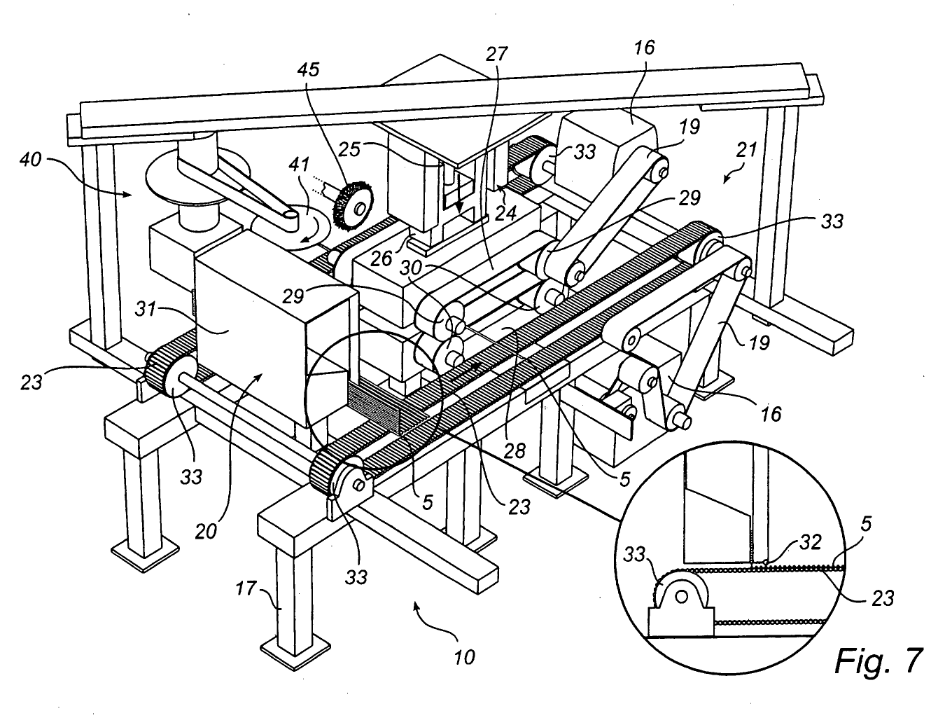

FIG. 7 shows another embodiment of the device 10 for the manufacture of welding electrodes 1 for use in manual metallic arc welding. Below will be described mainly the parts distinguishing this embodiment from the one described above. Rather than conveying the core wires 5 in their longitudinal extension up to the holding means 23 and thereafter displace them past the sawing device vertically in inter-parallel relationship the core wires 5 are collected in a bunch with the wires located horizontally in inter-parallel relationship in a magazine 31 in the feed-in portion 20 of the device. At the bottom of said magazine there is an opening in front of which is arranged a distributor 32 in the form of a circular rod. The distributor serves to discharge one core wire at the time onto and along a combined holding means and conveyor belt 23. The magazine 31 is configured as a box having a length slightly exceeding that of the core wires 5 that it is intended to receive. The magazine 31 and the distributor 32 are fixedly mounted across the conveyor belt 23 but if the core wires 5 to be slit by the machine vary considerably as to their diameter it could be suitable to change the distance between the conveyor belt 23 and the distributor 32 by raising or lowering the latter. The distance between the conveyor belt 23 and the distributor 32 is chosen to ensure that only one core wire 5 may pass below the lower edge of the distributor 32. In the magazine 31, the position of the core wires 5 is controlled in such a manner that their ignition ends to be, i.e. the ends of the core wires 5 that are to be slit by the device 10 in question, are pushed against the face of the magazine 31 that is turned towards the slitter 40. This is performed either manually when the core wires 5 are being placed inside the magazine 31, or preferably by means of a guide means 15. The holding means/conveyor belt 23 consists of a belt made from some suitable friction material to prevent the core wires 5 from moving when received on the belt. FIG. 7 shows the belt in a cross-sectional view. The conveyor belt 23 travels around two driving wheels 33, located one at each end of the device 10, and one of these driving wheels 33 is actuated by a drive unit 16 via a transmission belt 19. In addition, the conveyor belt 23 is divided into two parts. In its crosswise direction relative to the direction of advancement, the conveyor belt 23 has a profiled configuration either in the form of a saw-tooth pattern or of a somewhat softer, more rounded profiled configuration in the form of juxtaposed semicircular rods the convex face of which protrudes from the conveyor belt 23. The spacing between the tip of each rod or saw-tooth apex is chosen to ensure that when a core wire 5 is received in the depression thus formed between the tips or apices, the core wire does not contact the bottom face of the depression, i.e. the continuous face of the conveyor belt 23. This profiled configuration including tips and depressions and with faces therebetween that are not vertical, assuming that the conveyor belt extends flat in a horizontal position, makes it possible to use the conveyor belt for core wires 5 having different diameter sizes. Although it is true that the core wires 5 will assume a position at different levels inside the depressions, this is a situation that may be handled by the following parts of the device 10, for instance by level adjustment of the slitter. It should be mentioned, however, that when device 10 is used, welding electrodes 1 of identical diameter are produced in batches.

The core wires 10 are collected and advanced in the device 10 towards and past the slitter 40. In this embodiment, the slitter 40 consists of a circular saw 41, which is attached on an arm 42 arranged to be raised and lowered. The adaptation of the level of the circular saw 41 is effected in order that the slit in the core wire 5 be positioned in the correct place. In this embodiment it is assumed that a welding electrode 1 in accordance with FIG. 3 is to be produced. The circular saw 41 rotates counter to the direction of movement of the core wires 5. In this manner, the core wires 5 are pulled up against the circular saw 41. The core wires 5 are held in position in their profiled spaces in the holding means/conveyor belt 23 by movement constraining means 24 consisting of two constraining belts, one upper 27 and one lower 28, which are actuated by upper and lower driving wheels 29 and 30, respectively, the upper constraining belt 27 positioned vertically above the conveyor belt 23 and the lower one below the conveyor belt 23. The mutual positions of the belts are such that the upper constraining belt 27 is positioned immediately above the lower constraining belt 28 and in contacting relationship, however, while sandwiching core wires 5 between them. The plane formed between the two constraining belts 27, 28 for accommodation of the core wires 5 extends immediately above the upper face of the conveyor belt 23. As appears from FIG. 7, in the horizontal plane the two constraining belts 27, 28 are laterally displaced towards the slitter 40 relative to the conveyor belt 23. The reason for this arrangement is that the constraining belts 27, 28 are to lift the core wires 5 slightly off the conveyor belt 23 when the latter have arrived up to this point in the device 10. Because a movement constraining means 24 is arranged above and connected to the constraining belts 27, 28 for the purpose of applying pressure on the upper and the lower constraining belts 27 and 28, respectively, the core wires 5 are held captive in the position and in the place in which they were introduced between the constraining belts 27, 28. The pressure exerted on the core wires 5 by the movement constraining means 24 via a compression cylinder 25 and a frame 26 must be of a magnitude able to generate sufficient friction between the core wires 5 and the constraining belts 27, 28 to maintain the wires in position during the sawing operation. The compression cylinder 25 forces the upper constraining belt 27 against the lower one 28, which is fixedly mounted. Once the slit has been formed in the core wires 5 in the sawing operation the movement constraining means 24 releases the core wires 5, whereby the latter resume their positions in the profiled spaces in the conveyor belt 23. In the feed-out portion 21 of the device 10 the core wires are discharged into a magazine of suitable design for this purpose, for further transportation and working.

In order to achieve the desired results from the formation of the slit 7 in the core wires 5 by sawing a coated circular saw 41 preferably is used. Also, it has been found to be suitable to supply a cutting fluid via a nozzle 43, where the circular saw 41 meets the end portion of the core wires. In the initial stages of developing the device 10 the core wires 5 had a tendency to be pulled askew between the constraining belts 27, 28. This produced inferior sawing results with consequential risks for damages to the device 10 and to the core wires 5. It turned out that part of the cutting fluid landed on the friction faces of the constraining belts 27, 28, with resulting insufficient friction between the belts and the wires 5 despite the application of considerable pressure being applied via the compression cylinder 25. In order to obviate this problem so called air knives 44 were provided, said knives arranged to spray highly pressurized air onto the constraining belts 27, 28 above and below the circular saw 41. These air knives 44 are not shown in the drawing figures.

It has likewise been found necessary to provide a round steel-wire brush 45 adjacent the area of the device 10 where the core wires leave the constraining belts 27, 28. The brush 45 removes by brushing so called burr, which forms at the bottom of the slit 7 during the forming of the latter by sawing and which, if allowed to remain, negatively affects the welding capacity of the finished welding electrode 1. The brush 45 is placed above and immediately after the slitter 40 but ahead of the point, where the core wires 5 leave the movement constraining means 24 as seen in the direction of travel of the core wires.

As will be appreciated numerous modifications of the two embodiments are possible within the scope of protection of the invention also in this case defined in the appended claims. For example, the device 10 and its collection magazine 11 could be arranged horizontally in that a further conveyor belt advances the core wires 5 past the saw blade 12, which in this case extends horizontally. In addition, instead of the saw blade 12 a milling cutter or other suitable equipment for the cutting of the recess 7 could be used. In order to obtain other shapes of the slit 7 it might be necessary to arrange two or several saw blades 12 or to make the core wires 5 pass through the collection magazine 11 while assuming a different position than a horizontal one. The drive of the device 10 need not either be as shown in the embodiments herein but could also be coupled to a drive which is common to the entire manufacturing process. The important feature of the drive is that the various components forming part thereof are synchronised relative to one another.

1. A welding electrode for use in manual arc-welding operations, said electrode comprising:
a core wire having an arc ignition portion including an arc ignition face, the cross-sectional area of said arc ignition portion being reduced relative to the main cross section of the core wire, wherein said arc ignition portion is formed with at least one recess, the mouth of which opens in the longitudinal lateral face of the core wire.

2. A welding electrode including a core wire as claimed in claim 1, wherein the mouth of said recess also has an extension in over the arc ignition face.

3. A welding electrode including a core wire as claimed in claim 1, wherein said recess is a notch.

4. A welding electrode including a core wire as claimed in claim 1, wherein said recess opens in two oppositely positioned lengthwise lateral-face portions of the core wire.

5. A welding electrode including a core wire as claimed in claim 4, wherein said recess forms a slit.

6. A welding electrode including a core wire as claimed in claim 1, wherein said recess is rectilinear.

7. A welding electrode including a core wire as claimed in claim 5, wherein the mouth of said recess has an extension as seen in the longitudinal direction of the welding electrode.

8. A welding electrode including a core wire as claimed in claim 1, wherein said recess extends through the centre of the ignition face.

9. A welding electrode including a core wire as claimed in claim 1, which is coated with a material that forms slag and shielding gas during the welding operation and wherein said recess has a filler of said slag and shielding-gas forming material.

10. A welding electrode comprising a core wire as claimed in claim 9, wherein said recess is filled with the material forming slag and shielding gas.

11. A welding electrode comprising a core wire as claimed in claim 1, wherein said recess extends 3-9 mm in the lengthwise direction of the welding electrode and have a width, calculated across the longitudinal direction of the electrode that corresponds to a reduction of the diameter of the core wire by 30-40%.

12. A device in the manufacture of welding electrodes for use in manual metallic arc welding operations, said manufacturing process comprising a unit for the manufacture of core wires and a unit for applying on said core wires a material forming slag and a shielding gas during the welding operation, wherein said device has at least one shaping unit formed with at least one slitting means for forming at least one slit in one of the end portions of said core wires, and at least one holding means, in which said core wires are arranged to be collected in order to be advanced sequentially past the slitting means.

13. A device as claimed in claim 12, said device comprising a conveyor, arranged to displace the core wires in their longitudinal direction.

14. A device as claimed in claim 12, said device comprising a conveyor, arranged to displace the core wires in their transverse direction.

15. A device as claimed in claim 14, wherein said conveyor is arranged to displace the core wires in their transverse direction in the section of the slitting means.

16. A device as claimed in claim 12, wherein said conveyor is also arranged to displace the core wires in inter-parallel relationship in the section of the slitting means.

17. A device as claimed in claim 12, wherein the conveyor is also a holding device.

18. A device as claimed in claim 12, wherein said shaping unit is placed after the cutting unit and before the application unit, as seen in the order of manufacture.

19. A device as claimed in claim 12, wherein in the area of said one end portion of the core wires is formed with an opening for access by the slitting means.

20. A device as claimed in claim 12, wherein said device is formed with a guide to guide the core wires towards said slitting means.

21. A device as claimed in claim 12, wherein said slitting means is formed with a sawing tool.

22. A device as claimed in claim 21, wherein said slitting means comprises a saw band.

23. A device as claimed in claim 22, wherein said saw band is continuous.

24. A device as claimed in claim 12, wherein a holding device is arranged to displace to core wires in an essentially vertical direction.

25. A device as claimed in claim 12, wherein a holding device is arranged to displace the core wires in an essentially horizontal direction.

26. A device as claimed in claim 24, wherein the holding device is arranged to displace the core wires past said slitting tool by making use of the inherent gravity of the core wires.

27. A device as claimed in claim 12, wherein the direction of movement of the cutting part of the slitting means form an angle relative to the said one end portion of the core wires.

28. A device as claimed in claim 23, wherein said saw band is arranged to travel around deflection wheels.

29. A device as claimed in claim 12, wherein a holding device is arranged to retain the core wires in an essentially horizontal position.

30. A device as claimed in claim 21, wherein said slitting means comprises a circular saw blade.

31. A device as claimed in claim 12, wherein a holding device has a wedge-shaped profile configuration for reception therein of said core wires.
